(19) United States
(12) Patent Application Publication
(10) Pub. No.: US 2023/0205034 A1
(43) Pub. Date: Jun. 29, 2023

(54) ELECTROCHROMIC DEVICE HAVING MULTILAYER POLYMER FILM AND METHODS OF MAKING THE SAME

(71) Applicant: Gentex Corporation, Zeeland, MI (US)

(72) Inventors: William L. Tonar, Holland, MI (US); David J. Cammenga, Zeeland, MI (US)

(21) Appl. No.: 18/088,959

(22) Filed: Dec. 27, 2022

Related U.S. Application Data
(60) Provisional application No. 63/293,936, filed on Dec. 27, 2021.

(51) Int. Cl. G02F 1/157; G02F 1/155; B32B 27/08; B32B 7/023; B32B 27/32

(52) U.S. Cl. CPC G02F 1/157; G02F 1/155; B32B 27/08; B32B 7/023; B32B 27/32; B60J 3/00

(57) ABSTRACT

An electrochromic device is provided that includes: a first substrate having a first surface and a second surface opposite the first surface, the first substrate having a multilayer polymer film; a first electrode; a second substrate having a third surface and a fourth surface opposite the third surface, the second substrate spaced from the first substrate with the second and third surfaces facing but spaced from one another; a second electrode; and an electrochromic layer positioned between the first and second electrodes. The first electrode is positioned between the second surface and the electrochromic medium and the second electrode is positioned between the third surface and the electrochromic medium. The multilayer polymer film includes a nonpolar polymer layer as an outermost layer closest to the electrochromic medium.

### CROSS-REFERENCE TO RELATED APPLICATION

This application claims priority to and the benefit under 35 U.S.C. § 119(e) of U.S. Provisional Patent Application No. 63/293,936, filed on Dec. 27, 2021, entitled “ELECTROCHROMIC DEVICE HAVING MULTILAYER POLYMER FILM AND METHODS OF MAKING THE SAME,” by William L. Tonar et al., the entire disclosure of which is incorporated herein by reference.

### TECHNOLOGICAL FIELD

The present embodiments generally relate to electrochromic devices and methods of making electrochromic devices. More particularly, the present embodiments relate to electrochromic devices having polymer substrates and methods of making such electrochromic devices.

### SUMMARY OF THE INVENTION

In one aspect of the invention, an electrochromic device is provided including: a first substrate having a first surface and a second surface opposite the first surface, the first substrate comprising a multilayer polymer film; a first electrode; a second substrate having a third surface and a fourth surface opposite the third surface, the second substrate spaced from the first substrate with the second and third surfaces facing but spaced from one another; a second electrode; and an electrochromic medium positioned between the first and second electrodes, wherein the first electrode is positioned between the second surface and the electrochromic medium and the second electrode is positioned between the third surface and the electrochromic medium, wherein the multilayer polymer film comprises a nonpolar polymer layer as an outermost layer closest to the electrochromic medium.

In another aspect of the invention, an electrochromic device is provided including: a first substrate having a first surface and a second surface opposite the first surface, the first substrate comprising a polymer; a multilayer polymer film provided on the second surface; a first electrode provided on the multilayer polymer film; a second substrate having a third surface and a fourth surface opposite the third surface, the second substrate spaced from the first substrate with the second and third surfaces facing but spaced from one another; a second electrode provided on the third surface; and an electrochromic medium positioned between the first and second electrodes, wherein the multilayer polymer film comprises a plurality of co-extruded polymer layers.

In another aspect of the invention, an electrochromic device is provided including: a first substrate having a first surface and a second surface opposite the first surface, the first substrate comprising a polymer; a multilayer polymer film provided on the second surface; a first electrode provided on the multilayer polymer film; a second substrate having a third surface and a fourth surface opposite the third surface, the second substrate spaced from the first substrate with the second and third surfaces facing but spaced from one another; a second electrode provided on the third surface; and an electrochromic medium positioned between the first and second electrodes, wherein the multilayer polymer film comprises a plurality of separately extruded polymer layers that are subsequently laminated together to form the multilayer polymer film prior to application to the first substrate.

In another aspect of the invention, a method of making an electrochromic device is provided including: providing a first substrate having a first surface and a second surface opposite the first surface, wherein the first substrate is made of a polymer; providing a second substrate having a third surface and a fourth surface opposite the third surface; co-extruding a first polymer layer and a second polymer layer to form a multilayer polymer film; securing the multilayer polymer film to the second surface of the first substrate; securing a first electrode to the multilayer polymer film; providing a second electrode on the third surface of the second substrate; sealing the perimeters of the first and second substrates to provide a chamber therebetween; and providing an electrochromic medium in the chamber.

In another aspect of the invention, a method of making an electrochromic device is provided including: providing a first substrate having a first surface and a second surface opposite the first surface, wherein the first substrate is made of a polymer; providing a second substrate having a third surface and a fourth surface opposite the third surface; extruding a first polymer layer; extruding a second polymer layer; stacking the extruded first and second polymer layers; laminating the stacked extruded first and second polymer layers to form a multilayer polymer film; securing the multilayer polymer film to the second surface of the first substrate; securing a first electrode to the multilayer polymer film; providing a second electrode on the third surface of the second substrate; sealing the perimeters of the first and second substrates to provide a chamber therebetween; and providing an electrochromic medium in the chamber.

These and other features, advantages, and objects of the present device will be further understood and appreciated by those skilled in the art upon studying the following specification, claims, and appended drawings.

### BRIEF DESCRIPTION OF THE DRAWINGS

The embodiments will now be described with reference to the following drawings, in which:

FIG. 1 is a cross-sectional view of an electrochromic device;

FIG. 2A is an enlarged cross-sectional view of a portion designated as IIA, IIB of the electrochromic device shown in FIG. 1 according to a first implementation;

FIG. 2B is an enlarged cross-sectional view of a portion designated as IIA, IIB of the electrochromic device shown in FIG. 1 according to a second implementation;

FIG. 3 is a flowchart representing a first method of forming the electrochromic device in FIG. 1;

FIG. 4 is a schematic diagram representing a co-extrusion apparatus that may be used to performing the first method represented in FIG. 3;

FIG. 5 is a flowchart representing a second method of forming the electrochromic device in FIG. 1; and

FIG. 6 is a schematic diagram representing an extrusion/lamination apparatus that may be used to performing the second method represented in FIG. 5.

### DETAILED DESCRIPTION OF EMBODIMENTS

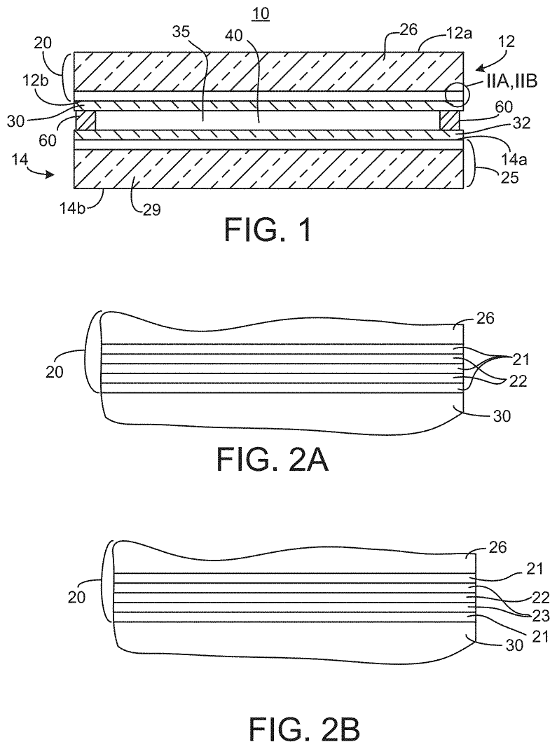

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the electrochromic device, and the term “rear” shall refer to the surface of the element further from the intended viewer of the electrochromic device. However, it is to be understood that the invention may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The embodiments below relate to an electrochromic device. Electrochromic devices are known that include an electrochromic layer that changes color and/or light transmission in response to an electrical stimulus applied to a pair of electrodes contacting the electrochromic layer. The electrodes are typically applied to opposing substrates. These substrates have typically been made of glass. However, as proposed in commonly assigned U.S. Pat. No. 9,766,528 and U.S. Patent Application Publication No. 2019/0324341 A1, the substrates may be made of plastic in order to reduce weight and enhance the ability to bend or otherwise form the substrates in various shapes.

U.S. Patent Application Publication No. 2019/0324341 A1 discloses a problem with using plastic substrates in an electrochromic device is that a solvent used in the electrochromic medium may dissolve the plastic substrate. Thus, the use of a multilayer film is proposed that includes polymer layers and inorganic layers that are deposited one at a time on the substrate using sputtering or vapor deposition. This publication recognizes that such layers may have defects that allow the solvent to reach the plastic substrate. However, by using a number of such layers, a tortuous path is created for the solvent to reach the plastic substrate.

As described below, alternative substrates made with multilayer polymer films are disclosed below that do not have such defects in the layers and thus provides an effective barrier that prevents the solvent from damaging the plastic substrate.

Referring to FIGS. 1, 2A, and 2B, reference numeral 10 generally designates an electrochromic device according to a first embodiment. The electrochromic device 10 includes a first substrate 12 having a first surface 12a and a second surface 12b opposite the first surface 12a. The first substrate 12 comprises a multilayer polymer film 20. The innermost surface of the multilayer polymer film 20 serves as the second surface 12b. A second substrate 14 is provided having a third surface 14a and a fourth surface 14b opposite the third surface 14a. The second substrate 14 is spaced from the first substrate 12 with the second and third surfaces 12b and 14a facing but spaced from one another to form a chamber 35. The electrochromic device 10 further includes a first electrode 30, a second electrode 32, and an electrochromic medium 40 positioned between the first and second electrodes 30 and 32. The first electrode 30 is positioned between the second surface 12b of the first substrate 12 and electrochromic medium 40 and the second electrode 32 is positioned between the third surface 14a of the second substrate 14 and electrochromic medium 40. According to the first embodiment, the multilayer polymer film 20 comprises a nonpolar polymer layer 21 as an innermost layer closest to the electrochromic medium 40.

By using a nonpolar polymer layer 21 as the outermost layer, the multilayer polymer film 20 will be resistant to the solvent of the electrochromic medium 40.

The multilayer polymer film 20 may further include a polar polymer layer 22. Such a polar polymer layer 22 is beneficial as it serves to block gases such as oxygen, whereas the nonpolar polymer layer 21 blocks moisture such as water. Additionally, the multilayer polymer film 20 may further include a plurality of alternating nonpolar and polar polymer layers 21 and 22. This combination of layers provides excellent gas and moisture impermeability.

Examples of nonpolar polymers include polypropylene (PP), polyethylene (PE), or other olefins. Examples of polar polymers include ethylene vinyl alcohol (EVOH) copolymers and polyvinyl alcohol (PVA).

Depending upon the polymers used for layers 21 and 22, the multilayer polymer film 20 may further include a plurality of tie layers 23, wherein one of the tie layers 23 is provided between pairs of the plurality of alternating nonpolar and polar polymer layers 21 and 22, as shown in FIG. 2B. Examples of suitable tie layer materials include anhydride modified polyethylene (AMP), ethylene vinyl acetate (EVA), ethylene methyl acrylate (EMA), acid modified olefin copolymers like ethylene acrylic acid (EAA) and ethylene methacrylic acid (EMAA).

The second substrate 14 may also be comprised of a second multilayer polymer film 25 with an innermost layer serving as the third surface 14a. The second multilayer polymer film 25 may also include the nonpolar polymer layer 21 as the innermost layer closest to the electrochromic medium 40. The second multilayer polymer film 25 may have similar construction to that of the first multilayer polymer film 20.

The outermost layers 26 and 29 of substrates 12 and 14, respectively, may be made of any one or more of polyethylene terephthalate (PET) and polyethylene naphthalate (PEN). The substrates 12 and 14 may have any shape and may be flat or curved. If curved, the substrates may be formed flat and then bent, or may be initially formed in a curved shape.

The electrodes 30 and 32 may be made from transparent conductive oxides (TCO), such as indium tin oxide (ITO), fluorine-doped tin oxide (F:SnO₂), aluminum-doped zinc oxide (AZO), indium-doped zinc oxide (IZO), or the like. In yet other examples, the first and/or second electrodes 30, 32 may form an insulator-metal-insulator (IMI) stack. Exemplary IMI stacks which may be utilized in combination with aspects of the present disclosure are disclosed in U.S. Pat. Nos. 8,368,992 and 10,444,575, the contents of which are incorporated herein by reference in their entirety.

The electrochromic device 10 may further include a perimeter seal 60 disposed between the substrates 12 and 14 to contain the electrochromic medium 40.

The electrochromic medium 40 may include an anodic species, a cathodic species, and the aforementioned solvent/plasticizer (polar solvents like propylene carbonate (PC)) that allows for good ionic mobility. Generally, the higher the solvent content, the higher the ionic mobility and the faster the coloring and clearing speed. However, the higher the concentration, the more damaging the solvent otherwise would be to the plastic substrates 12 and 14 but for the presence of the multilayer polymer films 20 and 25. The solvent/plasticizer content in the electrochromic medium is above preferably 20 weight percent, more preferably above 30 weight percent, most preferably above 40 weight percent.

One non-limiting example of an electrochromic element 40 is an electrochromic medium or layer, which includes at least one solvent, at least one anodic material, and at least one cathodic material. In one example, the electrochromic medium may comprise an anodic layer, a cathodic layer, and an electrolyte layer between the anodic and cathodic layers. Typically, both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity change from a first phase to a second phase. The electrochromic component may be a single-layer, single-phase component, multi-layer component, or multi-phase component, as described in U.S. Pat. No. 5,928,572 entitled “Electrochromic Layer and Devices Comprising Same,” U.S. Pat. No. 5,998,617 entitled “Electrochromic Compounds,” U.S. Pat. No. 6,020,987 entitled “Electrochromic Medium Capable of Producing a Pre-selected Color,” U.S. Pat. No. 6,037,471 entitled “Electrochromic Compounds,” U.S. Pat. No. 6,141,137 entitled “Electrochromic Media for Producing a Pre-selected Color,” U.S. Pat. No. 6,241,916 entitled “Electrochromic System,” U.S. Pat. No. 6,193,912 entitled “Near Infrared-Absorbing Electrochromic Compounds and Devices Comprising Same,” U.S. Pat. No. 6,249,369 entitled “Coupled Electrochromic Compounds with Photostable Dication Oxidation States,” and U.S. Pat. No. 6,137,620 entitled “Electrochromic Media With Concentration Enhanced Stability, Process for the Preparation Thereof and Use in Electrochromic Devices”; U.S. Pat. No. 6,519,072, entitled “Electrochromic Device”; and International Patent Application Serial Nos. PCT/US98/05570 entitled “Electrochromic Polymeric Solid Films, Manufacturing Electrochromic Devices Using Such Solid Films, and Processes for Making Such Solid Films and Devices,” and PCT/EP98/03862 entitled “Electrochromic Polymer System,” which are herein incorporated by reference in their entirety.

More specific examples of materials suitable for the substrates 12 and 14, seal 60, electrodes 30 and 32, and electrochromic medium 40 are found in U.S. Patent Application Publication No. 2019/0324341 A1, the entire disclosure of which is incorporated herein by reference.

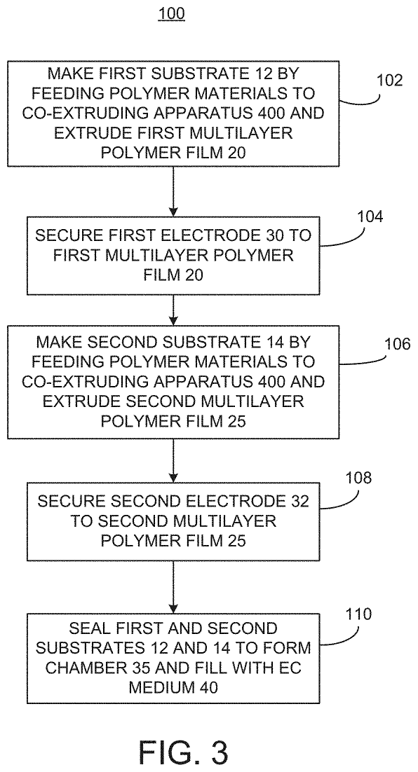

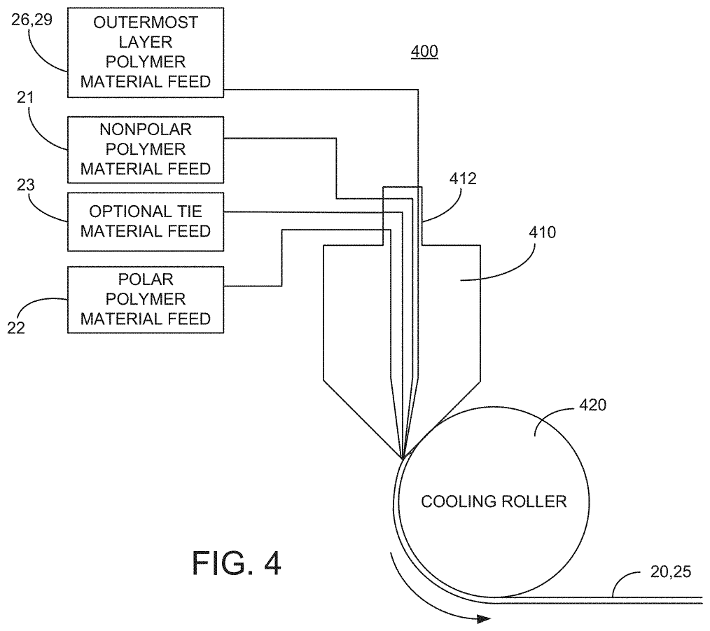

A first method 100 of making the electrochromic device 10 is described below with respect to FIGS. 3 and 4. FIG. 3 shows a flowchart of the method 100, whereas FIG. 4 shows a co-extrusion apparatus 400 that may be used in the method 100. According to the first method 100, in step 102 (FIG. 3), the first substrate 12 is prepared by feeding the different polymer materials forming the layers 21, 22, 26, and optionally 23 of the first multilayer polymer film 20 into a manifold 412 of a T die 410 of the co-extruding apparatus 400 (FIG. 4) and are extruded onto a cooling roller 420 to thereby form at least a portion of the first multilayer polymer film 20. If more layers are desired than the maximum number of layers that may be co-extruded at one time, the co-extruded layers may be folded or otherwise stacked and laminated to form the first multilayer polymer film 20. If desired, the combined layers in the multilayer polymer film can be made thinner (optical layer thickness) for example by stretching or further extruding the multilayer plastic film. Then, in step 104, the first electrode 30 may be deposited, coated, laminated, or otherwise secured to the first multilayer polymer film 20. It should be noted that other layers may be provided between the first multilayer polymer film 20 and the first electrode 30.

Next, in step 106, the second substrate 14 may be made by feeding the different polymer materials forming the layers 21, 22, 29, and optionally 23 of the second multilayer polymer film 25 into the co-extruding apparatus 400 and are extruded to thereby form at least a portion of the second multilayer polymer film 25. If more layers are desired than the maximum number of layers that may be co-extruded at one time, the co-extruded layers may be folded or otherwise stacked and laminated to form the second multilayer polymer film 25. It should be noted that the second multilayer polymer film 25 may be extruded with the first multilayer polymer film 20 simply by cutting the extrusion in half assuming films 20 and 25 include the same structure. Then, in step 108, the second electrode 32 may be deposited, coated, laminated, or otherwise secured to the second multilayer polymer film 25. Last, in step 110, the first and second substrates 12 and 14 may be sealed with perimeter seal 60 to form chamber 35, which is filled with the electrochromic medium 40 to thereby form the electrochromic device 10.

By extruding the films 20 and 25, the layers 21-23 and 26/29 may be formed without defects thereby providing a much greater degree of protection of the plastic substrates 12 and 14 from the solvent of the electrochromic medium while also providing very effective gas- and moisture-impermeable barriers.

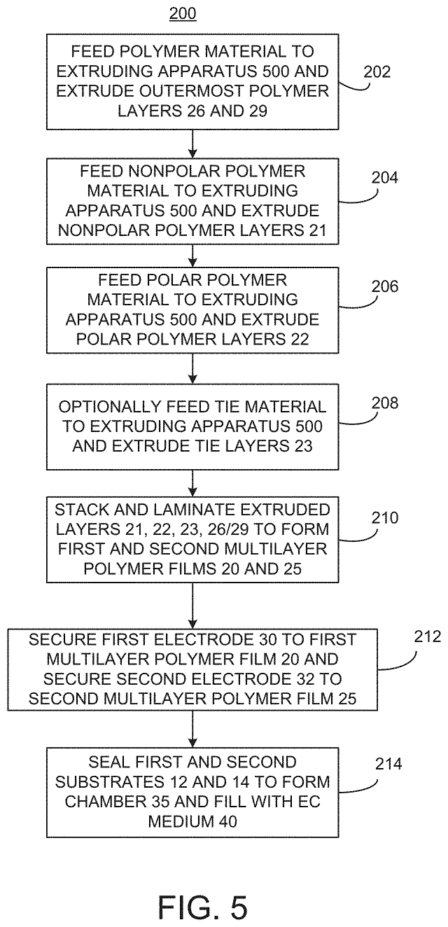

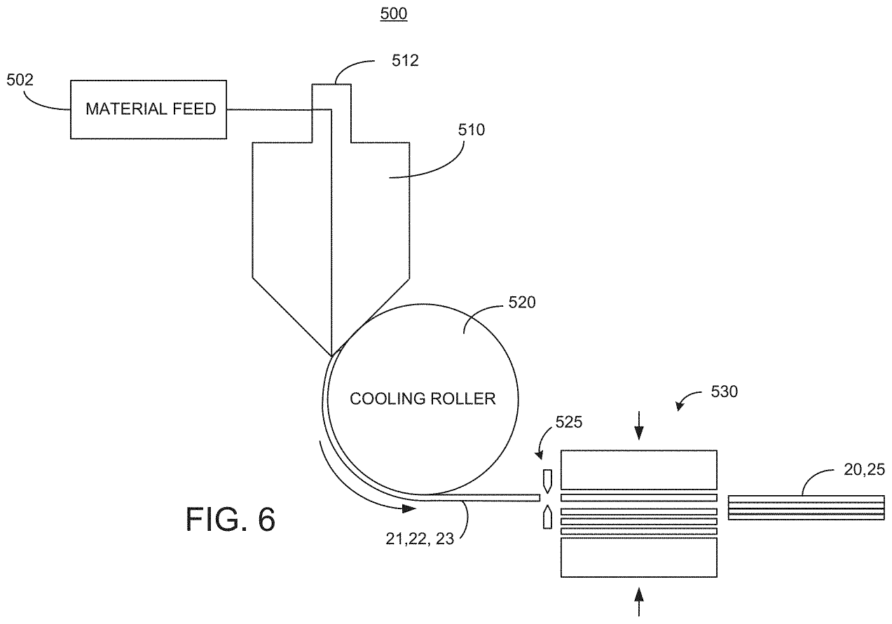

An alternative second method 200 of making the electrochromic device 10 is described below with respect to FIGS. 5 and 6. FIG. 5 shows a flowchart of the method 200, whereas FIG. 6 shows an extrusion/laminating apparatus 500 that may be used in the method 200. According to the second method 200, the polymer material forming the outermost layer 26/29 is fed from material feed 502 into the input 512 of a T die 510 of the extrusion/laminating apparatus 500 in step 202 (FIG. 5), extruded onto a cooling roller 520, cut by a cutter device 525, and stacked in a laminating device 530. Next, in step 204, the nonpolar polymer material forming the nonpolar polymer layers 21 of the first and second multilayer polymer films 20 and 25 is fed into the input 512 of a T die 510 of the extrusion/laminating apparatus 500 (FIG. 6), extruded onto the cooling roller 520, cut by the cutter device 525, and stacked in the laminating device 530. In step 206, the polar polymer material forming the polar polymer layers 22 of the first and second multilayer polymer films 20 and 25 is fed into the same extrusion/laminating apparatus 500 or a different extruding apparatus and is extruded, cooled, cut and stacked. In optional step 208, the material forming the tie layers 23 of the first and second multilayer polymer films 20 and 25 is fed into the same extruding apparatus 500 or a different extruding apparatus and is extruded, cooled, cut and stacked. Once all of the layers 21-23 and 26/29 are extruded, the extruded layers are laminated by the laminating device 530 to form the first and second multilayer polymer films 20 and/or 25 in step 210. It should be noted that where and when in the process the extruded material is cut into sheets is optional. All of the extrusion, laminating, electrode coating, electrochromic layer and perimeter seal application operations can be done with the multilayer substrate in roll form.

In step 212, the first multilayer polymer film 20 is laminated or otherwise secured to the first electrode 30 and the second multilayer polymer film 25 is laminated or otherwise secured to the second electrode 32. Then, in step 214, the first and second substrates 12 and 14 may be sealed with perimeter seal 60 to form chamber 35, which contains the electrochromic medium 40 to thereby form the electrochromic element 10. It is possible that a layered electrochromic medium 40 extends beyond the seal 60.

If the layers of multilayer polymer films differ in refractive index and are sub-micron in thickness, optical thin film effects can be designed into the multilayer films/substrates. Such optical thin film effects include anti-reflection, reflection of near infrared (IR), reflection of ultraviolet (UV), narrow band light reflection, and uniform light absorption by adding a dye/pigment. The resulting thickness of the substrate with the multilayer polymer film and electrode may be less than one half inch, less than 1 mm, less than 100 microns, or less than 50 microns.

For sunroof and window applications, it is desirable to have low haze for a clear view of the surroundings especially in bright sunlight environments. Some extruded plastic film layers are transparent but have a significant amount of haze. For instance, a nonpolar biaxially orientated polypropylene (BOPP) film manufactured by ERGIS is transparent but has a haze level (in air) as high as 5% in films as thin as 45 microns with a CIE-Y transmitted value of 94.1%. The amount of haze a nonpolar BOPP layer will contribute to the multilayer polymer film substrate is a function on the thickness of extruded BOPP layer used in the multilayer polymer substrate. The thinner the BOPP layer the lower the haze the layer will contribute to the total haze of the substrate. It is important to select the proper combination of polar and non-polar polymers and tailor their thickness to produce a substrate with a low total haze value that will be acceptable for use in window and sunroof applications. In window and sunroof applications, it is desirable to have a total substrate haze below 3%, preferably less than 2%, and most preferably less than 1%.

Dielectric effects could also be designed into the substrate. For instance, if one or more of the layers is a conductive plastic, a capacitor could be formed that could store charge to keep the electrochromic device 10 colored or cleared for extended periods of time without power. In another example, the films may be alternating layers of conductive carbon-enhanced silicon and nonconductive silicon. An antenna could be designed into the substrate for harvesting RF power to activate the electrochromic device 10.

Although the multilayer polymer films 20 and 25 are described above as being formed identically, the films 20 and 25 may have differing materials, layer thicknesses, or numbers of layers so as to exhibit different properties. For example, one film 20 may reflect UV while the other film 25 may reflect near IR.

Although both substrates 12 and 14 are disclosed as being made of a multilayer polymer film, the second substrate 14 may be made of glass or any other material.

As noted above, additional layers may be provided between the first multilayer film 20 and the first electrode 30 and between the second multilayer film 25 and the second electrode 32. Such layers may include the PML type barrier layers disclosed in commonly assigned U.S. Patent Application Publication No. 2019/0324341 A1, the entire disclosure of which is incorporated herein by reference. If the PML type barrier layers have defects, the non-polar underlayer 21 would seal those defects. The ceramic layer in the PML type barrier layer would also enhance the gas barrier properties of the extruded polymer multilayer films 20 and 25.

For sunroof and some window applications, the finished multilayer electrochromic device may be laminated between two bent pieces of glass. The glass bend in most sunroof applications is a 3D bend (such as a spherical bend not a 2D cylindrical bend). Commercial glass laminating material films, such as PVB, EVA, or urethane require heat and/or pressure to conform and bond to the glass. It is desirable that the finished electrochromic device can also be formed and bonded using these same known commercial materials and techniques. It is important to select the proper combination of polar and non-polar polymers and tailor their thickness to enable substrate forming and bonding at temperatures between 100 and 180 degrees C., more preferably between 110 and 150 degrees C., and more preferably between 110 and 140 degrees C.

The electrochromic device 10, as described herein, may be used as a vehicle sunroof. Such a sunroof can be made by laminating glass to both the first surface 12a of the first substrate 12 and the fourth surface 14b of the second substrate 14 to provide a laminated shatterproof construction. By forming the electrochromic device 10 with plastic substrates 12 and 14, the difficulties associated with otherwise having to bend glass substrates to have matching curvatures with uniform spacing could be avoided. Further, only two glass substrates would be used as opposed to four glass substrates as would be used if the substrates 12 and 14 were glass. This reduces weight and for cheaper glass to be used. In addition, one or more of the multilayer polymer films 20 and 25 may be constructed to reflect near-IR light so that such light does not pass through into the vehicle. UV light could similarly be reflected by one of the films 20 and 25.

The electrochromic device 10 may also be included in, for example, an architectural window, automobile windows, an aircraft window system, marine windows, spacecraft windows, a vehicle rearview mirror, any other mirror, a display device, a light filter, a camera filter, screens for watches, calculators and computer display screens, eye wear such as eyeglasses and sunglasses, sun visors, information display boards, digital billboards, and the like. A streamlined electrochromic insulated glass window could be made if the device included the following: glass substrate 14/second electrode 32/electrochromic layer 40/first electrode 30/multilayer plastic film substrate 12/gas/glass substrate.

It will be understood by one having ordinary skill in the art that construction of the described invention and other components is not limited to any specific material unless specified in the claims. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. An electrochromic device comprising:
a first substrate having a first surface and a second surface opposite the first surface, the first substrate comprising a multilayer polymer film;
a first electrode;
a second substrate having a third surface and a fourth surface opposite the third surface, the second substrate spaced from the first substrate with the second and third surfaces facing but spaced from one another;
a second electrode; and
an electrochromic medium positioned between the first and second electrodes, wherein the first electrode is positioned between the second surface and the electrochromic medium and the second electrode is positioned between the third surface and the electrochromic medium,
wherein the multilayer polymer film comprises a nonpolar polymer layer as an outermost layer closest to the electrochromic medium.

2. The electrochromic device of claim 1, wherein the multilayer polymer film further comprises a polar polymer layer.

3. The electrochromic device of claim 1, wherein the multilayer polymer film further comprises a plurality of alternating polar and nonpolar polymer layers.

4. The electrochromic device of claim 3, wherein the multilayer polymer film further comprises a plurality of tie layers, wherein one of the tie layers is provided between pairs of the plurality of alternating polar and nonpolar polymer layers.

5. The electrochromic device of claim 1, wherein the polymer layers are formed by co-extrusion.

6. The electrochromic device of claim 1, wherein the polymer layers are separately formed by extrusion and then laminated together.

7. The electrochromic device of claim 1, wherein the nonpolar polymer layer comprises a polymer selected from the group consisting of: polypropylene and polyethylene.

8. The electrochromic device of claims 3, wherein the optical thicknesses of the plurality of alternating polar and nonpolar polymer layers are selected to provide anti-reflective properties.

9. The electrochromic device of claim 3, wherein the optical thicknesses of the plurality of alternating polar and nonpolar polymer layers are selected to provide reflective properties with respect to a band of radiation.

10. The electrochromic device of claim 1, wherein the second substrate comprises a polymer.

11. The electrochromic device of claim 1, wherein the second substrate comprises a second multilayer polymer film.

12. A vehicle sunroof comprising the electrochromic device of claim 1.

13. An electrochromic device comprising:
a first substrate having a first surface and a second surface opposite the first surface, the first substrate comprising a multilayer polymer film;
a first electrode;
a second substrate having a third surface and a fourth surface opposite the third surface, the second substrate spaced from the first substrate with the second and third surfaces facing but spaced from one another;
a second electrode; and
an electrochromic medium positioned between the first and second electrodes, wherein the first electrode is positioned between the second surface and the electrochromic medium and the second electrode is positioned between the third surface and the electrochromic medium,
wherein the multilayer polymer film comprises a plurality of co-extruded polymer layers.

14. The electrochromic device of claim 13, wherein the multilayer polymer film comprises a nonpolar polymer layer as an outermost layer adjacent the first electrode.

15. The electrochromic device of claim 13, wherein the multilayer polymer film comprises a polar polymer layer.

16. An electrochromic device comprising:
a first substrate having a first surface and a second surface opposite the first surface, the first substrate comprising a multilayer polymer film;
a first electrode;
a second substrate having a third surface and a fourth surface opposite the third surface, the second substrate spaced from the first substrate with the second and third surfaces facing but spaced from one another;
a second electrode; and
an electrochromic medium positioned between the first and second electrodes, wherein the first electrode is positioned between the second surface and the electrochromic medium and the second electrode is positioned between the third surface and the electrochromic medium,
wherein the multilayer polymer film comprises a plurality of separately extruded polymer layers that are subsequently laminated together to form the multilayer polymer film.

17. The electrochromic device of claim 16, wherein the multilayer polymer film comprises a nonpolar polymer layer as an outermost layer adjacent the first electrode.

18. The electrochromic device of claim 16, wherein the multilayer polymer film comprises a polar polymer layer.

19. A method of making an electrochromic device comprising:
co-extruding a first polymer layer and a second polymer layer to form a multilayer polymer film functioning as a first substrate having a first surface and a second surface opposite the first surface;
providing a second substrate having a third surface and a fourth surface opposite the third surface;
forming a first electrode;
forming a second electrode;
assembling the first and second substrates to provide a chamber therebetween; and
providing an electrochromic medium in the chamber, wherein the first electrode is positioned between the second surface and the electrochromic medium and the second electrode is positioned between the third surface and the electrochromic medium.

20. The method of claim 19, wherein the first polymer layer is formed of a nonpolar polymer.

21. The method of claim 19, wherein the second polymer layer is formed of a polar polymer.

22. A method of making an electrochromic device comprising:
extruding a first polymer layer;
extruding a second polymer layer;
stacking the extruded first and second polymer layers;
laminating the stacked extruded first and second polymer layers to form a first substrate comprising a multilayer polymer film, the first substrate having a first surface and a second surface opposite the first surface;
providing a second substrate having a third surface and a fourth surface opposite the third surface;
providing a first electrode;
providing a second electrode;
assembling the first and second substrates to provide a chamber therebetween; and
providing an electrochromic medium in the chamber, wherein the first electrode is positioned between the second surface and the electrochromic medium and the second electrode is positioned between the third surface and the electrochromic medium.

23. The method of claim 22, wherein the first polymer layer is formed of a nonpolar polymer.

24. The method of claim 22, wherein the second polymer layer is formed of a polar polymer.
